(19) United States
(12) Patent Application Publication
(10) Pub. No.: US 2008/0164209 A1
(43) Pub. Date: Jul. 10, 2008

(54) WATER TREATMENT SYSTEMS AND METHODS

(76) Inventors: Orest Zacerkowny, Lasalle (CA); John Toohil, Ashland, MA (US); Joseph E. Zuback, Camarillo, CA (US)

Correspondence Address: LOWRIE, LANDO & ANASTASI, LLP;U0105, ONE MAIN STREET, SUITE 1100, CAMBRIDGE, MA, 02142, US

(21) Appl. No.: 11/765,181

(22) Filed: Jun. 19, 2007

Related U.S. Application Data
(60) Provisional application No. 60/883,640, filed on Jan. 5, 2007.

(51) Int. Cl. C02F 9/00; B01D 61/02; B01D 61/08; B01D 61/14; B01D 61/18; C02F 9/06; C02F 9/12; C02F 9/02; B01D 61/42; B01D 61/46; C02F 1/32

(52) U.S. Cl. 210/652; 210/143; 210/153; 210/170.09; 210/255; 210/93

(57) ABSTRACT

Systems and methods for treating water are provided. In certain examples, the system may include a first stage, a second stage fluidically coupled to the first stage and a third stage fluidically coupled to the second stage. In some examples, the system may provide treated water having a specific resistance of greater than or equal to 1 Megohm-cm. In certain examples, the water recovery rate using the system may be 90% or more by volume.

### PRIORITY APPLICATION

This application claims priority to U.S. Provisional Application No. 60/883,640 filed on Jan. 5, 2007, the entire disclosure of which is hereby incorporated herein by reference for all purposes.

### FIELD OF THE TECHNOLOGY

Embodiments of the technology disclosed herein relate generally to water treatment systems and methods. More particularly, embodiments disclosed herein relate to water treatment systems and methods that provide highly pure water with high water recovery rates.

### BACKGROUND

Water that contains hardness species such as calcium may be undesirable for some uses in industrial, commercial and household applications. The typical guidelines for a classification of water hardness are: zero to 60 milligrams per liter (mg/L) of calcium carbonate is classified as soft; 61 to 120 mg/L of calcium carbonate is classified as moderately hard; [2] to 180 mg/L of calcium carbonate is classified as hard; and more than 180 mg/L of calcium carbonate is classified as very hard.

Hard water can be softened by removing the hardness ion species. Examples of systems that remove such species include those that use ion exchange beds. In such systems, the hardness ions become ionically bound to oppositely charged ionic species that are mixed on the surface of the ion exchange resin. The ion exchange resin eventually becomes saturated with ionically bound hardness ion species and must be regenerated. Regeneration typically involves replacing the bound hardness species with more soluble ionic species, such as sodium chloride. The hardness species bound on the ion exchange resin are replaced by the sodium ions and the ion exchange resins are ready again for a subsequent water softening step.

Electrodeionization (EDI) is one process that may be used to soften water. EDI is a process that removes ionizable species from liquids using electrically active media and an electrical potential to influence ion transport. The electrically active media may function to alternately collect and discharge ionizable species, or to facilitate the transport of ions continuously by ionic or electronic substitution mechanisms. EDI devices can include media having permanent or temporary charge. Such devices can cause electrochemical reactions designed to achieve or enhance performance. These devices also include electrically active membranes such as semi-permeable ion exchange or bipolar membranes.

Continuous electrodeionization (CEDI) is a process wherein the primary sizing parameter is the transport through the media, not the ionic capacity of the media. A typical CEDI device includes selectively-permeable anion and cation exchange membranes. The spaces between the membranes are configured to create liquid flow compartments with inlets and outlets. A transverse DC electrical field is imposed by an external power source using electrodes at the bounds of compartments. Often, electrode compartments are provided so that reaction product from the electrodes can be separated from the other flow compartments. Upon imposition of the electric field, ions in the liquid are typically attracted to their respective counter-electrodes. The adjoining compartments, bounded by the permeable membranes facing the anode and facing the cathode, typically become ionically depleted and the compartments, bounded by the electroactive cation permeable membrane facing the anode and the electroactive anion membrane facing the cathode, typically become ionically concentrated. The volume within the ion-depleting compartments and, in some embodiments, within the ion-concentrating compartments, can include electrically active media or electroactive media. In CEDI devices, the electroactive media may include intimately mixed anion and cation exchange resin beads to enhance the transport of ions within the compartments and may participate as substrates for electrochemical reactions. Electrodeionization devices have been described by, for example, Giuffrida et al. in U.S. Pat. Nos. 4,632,745, 4,925,541 and 5,211,823, by Ganzi in U.S. Pat. Nos. 5,259,936 and 5,316,637, by Oren et al. in U.S. Pat. No. 5,154,809 and by Kedem in U.S. Pat. No. 5,240,579.

### SUMMARY

In accordance with a first aspect, a method of treating water is disclosed. In certain examples, the method comprises providing filtered water by reducing an amount of species in feed water by at least 90% using a first stage comprising a microfiltration device, providing partially treated water by reducing an amount of species in the filtered water by at least 95% using a second stage fluidically coupled to the first stage and comprising a reverse osmosis device, and providing treated water having a specific resistance of greater than or equal to 1 Megohm-cm by removing a sufficient amount of remaining ionic species from the partially treated water using a third stage fluidically coupled to the second stage and comprising an electrochemical device, wherein the treated water is provided at a water recovery rate of at least 90% by volume.

In accordance with an additional aspect, a method of treating feed water comprising calcium carbonate and silicon dioxide is disclosed. In certain examples, the method comprises passing the hard water to a first stage comprising a microfiltration device configured to provide filtered water, passing the filtered water from the first stage to a second stage fluidically coupled to the first stage, the second stage comprising a reverse osmosis device configured to provide partially treated water, and passing the partially treated water to a third stage fluidically coupled to the second stage, the third stage comprising an electrochemical device configured to remove a sufficient amount of remaining ionic species from the partially treated water to provide treated water having a specific resistance greater than or equal to 1 Megohm-cm, wherein the treated water is provided at water recovery rate of at least 90% by volume.

In accordance with another aspect, a system to provide treated water from feed water is disclosed. In certain examples, the system comprises a first stage comprising a microfiltration device effective to remove at least 90% of calcium carbonate from the feed water to provide filtered water, a second stage fluidically coupled to the first stage and comprising a reverse osmosis device effective to remove at least 95% of species remaining in the filtered water to provide partially treated water, and a third stage fluidically coupled to the second stage and comprising an electrochemical device effective to remove a sufficient amount of remaining ionic material to provide treated water having a specific resistance of greater than or equal to 1 Megohm-cm, wherein the treated water is provided at a water recovery rate of at least 90% by volume.

In accordance with an additional aspect, a system for treating water is provided. In certain examples, the system comprises a first device constructed and arranged to remove at least 90% of calcium carbonate from feed water to provide concentrate, a second device fluidically coupled to the first device, the second device constructed and arranged to remove at least 95% of calcium carbonate from the concentrate to provide partially treated water, and a third device fluidically coupled to the second device, the third device constructed and arranged to remove a sufficient amount of remaining ionic species in the partially treated water to provide treated water having a specific resistance greater than or equal to 1 Megohm-cm, wherein the treated water is provided at a water recovery rate of at least 90% by volume.

In accordance with an additional aspect, a method of facilitating treatment of hard water comprising calcium carbonate and silicon dioxide to provide treated water having a specific resistance of greater than or equal to 1 Megohm-cm at a water recovery rate of at least 90% by volume is disclosed. In certain examples, the method comprises providing a system comprising a first stage configured to receive the hard water and comprising a microfiltration device configured to provide filtered water, a second stage fluidically coupled to the first stage and comprising a reverse osmosis device configured to provide partially treated water, and a third stage fluidically coupled to the second stage and configured to remove a sufficient amount of remaining ionic species from the partially treated water to provide the treated water having a specific resistance greater than or equal to 1 Megohm-cm at a water recovery rate of at least 90% by volume.

Additional features, aspects and examples are disclosed in more detail below.

### BRIEF DESCRIPTION OF THE FIGURES

Certain features, aspects, examples and embodiments are described below with reference to the figures in which:

FIG. 1A is a system for treating water comprising a first stage, a second stage fluidically coupled to the first stage and a third stage fluidically coupled to the second stage, in accordance with certain examples;

FIG. 1B is a system for treating water comprising a first stage, a second stage fluidically coupled to the first stage and a third stage fluidically coupled to the second stage at two sites to provide concentrate from the third stage back to the second stage, in accordance with certain examples;

FIG. 2 is a system for treating water comprising a first stage, a second stage fluidically coupled to the first stage and a third stage fluidically coupled to the second stage and an additional stage fluidically coupled to the first and second stages, in accordance with certain examples;

FIG. 3 is a system for treating water comprising a first stage, a second stage fluidically coupled to the first stage and a third stage fluidically coupled to the second stage and an additional stage fluidically coupled to the second stage, in accordance with certain examples;

FIG. 4A is a system for treating water comprising a first stage, a second stage fluidically coupled to the first stage and a third stage fluidically coupled to the second stage, a fourth stage fluidically coupled to the first stage and the second stage, and a fifth stage fluidically coupled to the second stage, in accordance with certain examples;

FIG. 4B is a system for treating water comprising a first stage, a second stage fluidically coupled to the first stage and a third stage fluidically coupled to the second stage at two sites to provide concentrate from the third stage back to the second stage, a fourth stage fluidically coupled to the first stage and the second stage, and a fifth stage fluidically coupled to the second stage, in accordance with certain examples;

FIG. 5 is a system for treating water having an intervening stage between a second and third stage, in accordance with certain examples; and

FIG. 6 is a system comprising a controller, in accordance with certain examples.

It will be recognized by the person of ordinary skill in the art, given the benefit of this disclosure, that the dimensions and representation of certain elements in the figures may have been enlarged, distorted or otherwise shown in a non-conventional manner to provide a more user-friendly description of the technology. The passages or connections shown in the figures to fluidically couple the various stages of the systems may take any form, shape or geometry and are shown as linear in the figures only for convenience purposes.

### DETAILED DESCRIPTION

It will be recognized by the person of ordinary skill in the art, given the benefit of this disclosure, that certain embodiments of the systems and methods disclosed herein provide significant advantages over existing systems including, but not limited to, high water recoveries, purification of water having high hardness levels, extended membrane lifetimes, water treatment at remote sites, rapid system set-up and the like.

In accordance with certain examples, a system for treating water and comprising a first stage comprising a filtration device, a second stage fluidically coupled to the first stage and comprising a reverse osmosis device, and a third stage fluidically coupled to the second stage and comprising an electrochemical device is provided. As used herein, the term “fluidically coupled” refers to the case where two or more devices or stages are connected in a suitable manner such that fluid may pass or flow from one device or stage to the other device or stage. When two or more devices are fluidically coupled, additional devices or stages may be present between the two or more devices, or the devices may be connected such that fluid passes directly from a first device to a second device without any intervening devices or stages. “Fluidically coupled” may be used interchangeably in certain instances herein with the term “fluidly connected.” Two or more devices may be fluidically coupled, for example, by connecting an outlet of a first device to an inlet of a second device using tubing, a conduit, a channel, piping or the like.

In accordance with certain examples, the systems disclosed herein may be effective to receive water having high levels of calcium carbonate and/or silicon dioxide and treat the water such that a specific resistance of greater than or equal to 1 Megohm-cm is discharged from the system. In other examples, the system is effective to treat the water and provide treated water at a water recovery rate of greater than or equal to 90% by volume. By fluidically coupling the three stages and by removal of certain species at each stage, the water recovery rate of the system may be increased as compared to systems using reverse osmosis coupled to electrochemical deionization. For example, by filtering out a substantial portion of the species in the first stage, the efficiencies of the second and third stages may be greatly enhanced to increase the overall efficiency of the system and to increase the water recovery rate. In certain configurations, each of the first stage, second stage and third stage may provide a water recovery rate of greater than 95% by volume such that the overall water recovery rate of the system is 90% by volume or more. In some examples, the first stage provides a water recovery rate of 99% by volume or more, the second stage provides a water recovery rate of greater than 95% by volume and the third stage provides a water recovery rate greater than 95% by volume. In some examples, the system may be effective to treat the water and provide zero discharge. In additional examples, the system may be effective to provide at least 90%, by volume, water recovery from feed water having high levels of calcium carbonate and silicon dioxide without any pre-treatment steps, e.g., lime softening to precipitate CaCO₃, prior to passing the feed water to the first stage of the system. Certain additional examples, embodiments and features of the systems and methods disclosed herein are described in more detail below.

In certain examples, the systems and methods disclosed herein are configured to treat hard water. As used herein and as discussed above, hard water refers to water that includes more than about 120 mg/L calcium carbonate. The hard water may also include other species, such as inorganic compounds (e.g., silicon dioxide), organic compounds, microorganisms such as bacteria, fungi, viruses, etc., spores, particulate matter and the like. For example, the feed water may include calcium carbonate levels of about 200 mg/L or more. In some examples, the feed water may include high levels of SiO₂, e.g., 100 mg/L SiO₂ or more, either alone or with other salts such as CaCO₃. In some examples, the water may be subjected to one or more pre-treatment steps, e.g., pH, adjustment, precipitation, dechlorination, clarification, aeration, pre-filtration or the like prior to passing the water to the first stage of the systems disclosed herein, whereas in other examples, no pre-treatment steps are performed. The water recovery rate of the system may be determined, for example, by sensing or determining a volume of feed water passed to the system and sensing or determining a volume of treated water discharged from the system. In certain examples, the ratio of the volume of discharged treated water to the volume of feed water is 0.9 or greater.

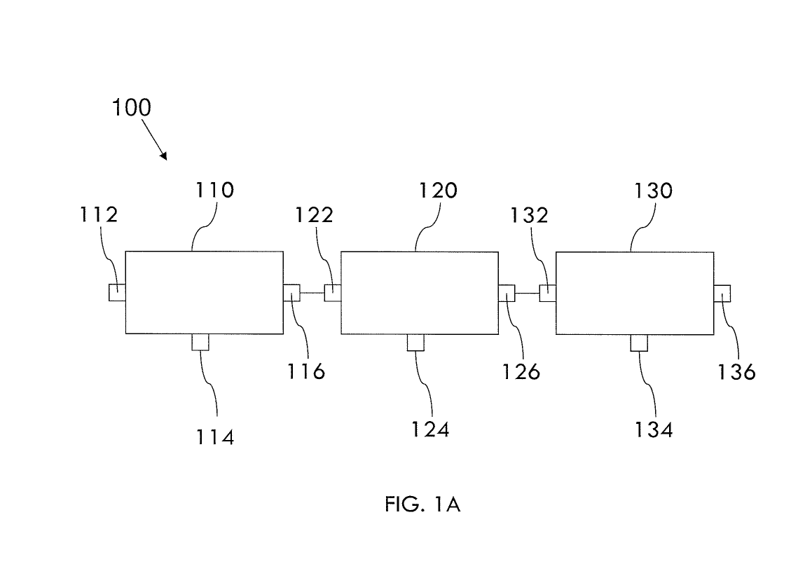

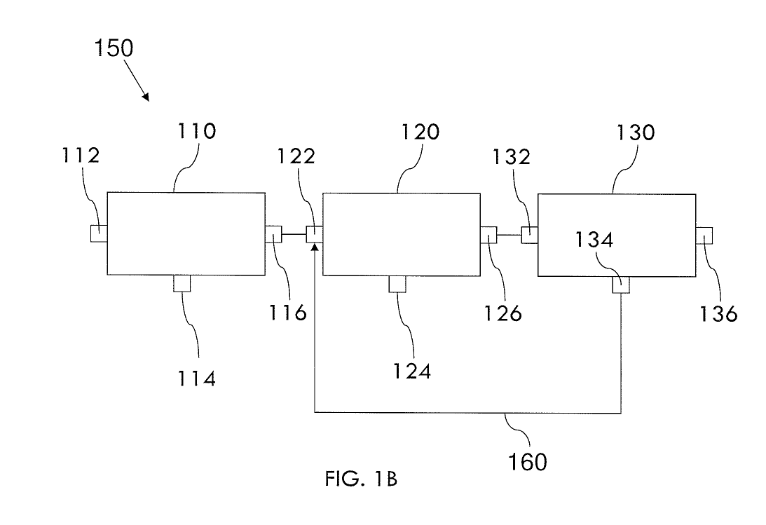

In accordance with certain examples, an illustration of a system for treating water is shown in FIG. 1A. The system 100 comprises a first stage 110 fluidically coupled to a second stage 120. The second stage 120 may be fluidically coupled to a third stage 130. The first stage 110 typically includes at least one inlet 112 for receiving water, an outlet 114 for discharging reject and an outlet 116 for discharging permeate. The outlet 116 for discharging permeate may be fluidically coupled to an inlet 122 of the second stage 120. The second stage 120 receives permeate from the first stage 110 through the inlet 122 and may discharge reject through outlet 124 and permeate through outlet 126. The outlet 126 may be fluidically coupled to an inlet 132 of the third stage 130. Permeate from outlet 126 may pass to inlet 132 of the third stage 130, reject from the third stage 130 may be discharged from outlet 134 and treated water from the third stage 130 may be discharged from outlet 136. In certain examples, the system 100 may be effective to receive hard water and to provide treated water having a specific resistance of greater than 1 Megohm-cm. In certain examples, the water recovery rate may be 90% or more even where hard water is feed to the system without any pre-treatment. For example, a 90% water recovery rate may be obtained from feed water having high levels of CaCO₃ and high levels of SiO₂.

In certain examples, the first stage 110 may be, or may include, a filtration device. The exact nature and form of the filtration device may vary depending on the desired results, the composition of the feed water and the like. In certain examples, the filtration device may include, or use, microfiltration, ultrafiltration, nanofiltration or other comparable filtration devices or techniques. A filtration device typically uses a semi-permeable membrane that may be configured to permit certain species to pass through the membrane while retaining other species. For example, the membrane may be constructed and arranged to permit species having a size below a cut-off value, e.g., 1 micron, to pass through the membrane, while species having a size larger than the cut-off value may not pass through the membrane to any substantial degree. The semi-permeable membrane may be comprised of, or include, any material that is at least partially permeable to water and retentive of precipitated solids, such as sub-micron filtration media. Illustrative materials include, but are not limited to, cellulose, nylon, polypropylene, polysulfone, polyethersulfone, polyethylene and fluoropolymers such as, for example, polyvinylidene difluoride (PVDF) and polytetrafluoroethylene (PTFE), and combinations thereof. The membrane may be hydrophobic, hydrophilic or amphipathic, or may be, or have been, subjected to chemical treatment to render some portion of the membrane hydrophobic, hydrophilic or amphipathic. The membrane may be any shape such as, tubular, flat, disc-like, circular and the like. Because the membrane may be exposed to elevated pressures, it may be supported by a more rigid material, for example, polyethylene or other polymeric materials, to prevent the membrane from ballooning or bursting. Illustrative commercially available membranes suitable for use in the systems and methods disclosed herein include, but are not limited to, an asymmetric membrane of PVDF (KYNAR®) having a nominal pore size of 0.1 to 0.2 microns. The PVDF membrane may be supported, for example, by a tube of sintered high density polyethylene (HDPE). The sintered HDPE support material may be extruded so that it does not contain any parting lines that might provide a point of weakness. Additional suitable filtration devices and systems are commercially available from Siemens Water Technologies, Inc. and include, for example, MEMTEK® microfiltration systems and MEMCOR® membrane systems (e.g., MEMCOR® CS, MEMCOR® XS, MEMCOR® CP and MEMCOR® XP membrane systems). Other suitable filtration devices will be readily selected by the person of ordinary skill in the art, given the benefit of this disclosure.

In accordance with certain examples, the exact configuration of the filtration device may vary depending on the intended use of the system, the flow rate, the sizes and amounts of species in the water and the like. For example, a membrane may be placed within a channel or conduit such that certain species in water passed to the membrane may pass through the membrane, whereas other species are retained and may be passed to a reject stream at about a ninety degree angle from a stream of fluid that is passed by the membrane. In certain examples, the filtration device may employ cross-flow filtration using suitable techniques and membranes, such as, for example, those described in U.S. Pat. No. 6,270,671, the entire disclosure of which is hereby incorporated herein by reference. For example, water may be passed through a tube that comprises a porous semi-permeable membrane. The membrane may be comprised of sub-micron filtration media, e.g., filtration media having a pore size of less than 1 micron. A portion of the water may pass through the lumen of the tube while another portion of the water may permeate through the walls of the tubular membrane and may be collected from outside the tubular membrane. It is this filtrate or permeate that may contain lower levels of species and that may be passed to the second stage. The water passing the length of the tube may flow to waste through the outlet 114, or may be recycled to the first stage 110, as discussed further below. The exact cross-sectional shape and diameter of the membrane may vary depending on the desired flow rates, species in the feed water and the like. In examples, where a tubular membrane is employed, the diameter of the tubular membrane may be ½ inch, ¾ inch or 1 inch (also referred to in certain instances herein as a ½ inch module, a ¾ inch module or a 1 inch module, respectively).

In some examples, the second stage may be, or may include, a reverse osmosis device. Reverse osmosis (RO) is a technique that provides for the removal of dissolved species from a water supply. Water may be supplied to one side of an RO membrane at elevated pressure, and purified water may be collected from the low pressure side of the membrane. The RO membrane may be structured such that water may pass through the membrane while other compounds, for example, dissolved ionic species, may be retained on the high pressure side. The “concentrate” or “reject” that contains an elevated concentration of ionic species may then be discharged or recycled, while the permeate, typically containing a reduced concentration of species, may be discharged to the third stage 130 for further treatment. Illustrative reverse osmosis devices, methods of use, and methods of making are described by, for example, Atnoor et al. in U.S. Pat. No. 6,328,896, Arba et al. in U.S. Pat. No. 6,398,965, DiMascio et al. in U.S. Pat. No. 6,514,398, Jha et al in U.S. Pat. No. 5,032,265 and Shorr et al. in U.S. Pat. No. 6,270,671. Illustrative commercially available reverse osmosis devices and systems include, but are not limited to, those available from Siemens Water Technologies, Inc. such as, for example, the Vantage Series RO Systems, ValueMAX™ RO Systems, Purelab® RO Systems, BevMAX™ RO Systems and the like. Additional suitable RO devices and systems will be readily selected by the person of ordinary skill in the art, given the benefit of this disclosure. In certain examples, the second stage may comprise a reverse osmosis device that is configured for high efficiency reverse osmosis operation, such as the configurations described in U.S. Pat. Nos. 5,925,255 and 6,537,456, the entire disclosure of which is hereby incorporated herein by reference for all purposes.

In some examples, the third stage may be, or may include, an electrochemical device such as, for example, an electrodeionization device, a continuous deionization device or an electrodialysis device. Electrochemical devices suitable for use in the methods and systems disclosed herein typically use either chemical or electrical deionization to replace specific cations and anions with alternative ions. In chemical deionization, an ion exchange resin may be used to replace ions contained in the feed water. The ions on the resin may be recharged by periodically passing a recharging fluid through the resin bed. This fluid may be an acid that replenishes the supply of hydrogen ions on the cation exchange resin. For anion exchange resins, the resin may be replenished by passing a base through the resin, replacing any bound anions with hydroxyl groups and preparing the resin for additional anion removal. In electrodeionization, the resin or resins may be replenished by hydrogen and hydroxyl ions that are produced from the splitting of water by application of electric current to the deionization unit. In continuous electrodeionization (CEDI), the ions may be replaced while the feed water is being treated, and thus no separate recharging step is required. Additional devices that use electric current or electric field to reduce the concentration of ionic compounds in a water sample and that are suitable for use in, or as, the third stage, include but are not limited to, electrodialysis (ED), electrodialysis reversal (EDR) capacitive deionization, and reversible continuous electrodeionization (RCEDI). Illustrative electrochemical deionization devices, methods of use, and methods of making are described by, for example, Giuffrida et al. in U.S. Pat. Nos. 4,632,745, 4,925,541, 4,956,071 and 5,211,823, by Ganzi in U.S. Pat. Nos. 5,259,936, by Ganzi et al., in 5,316,637, by Oren et al. in U.S. Pat. No. 5,154,809, by Kedem in U.S. Pat. No. 5,240,579, by Liang et al. in U.S. patent application Ser. No. 09/954,986 and U.S. Pat. No. 6,649,037, by Andelman in U.S. Pat. No. 5,192,432, Martin et. al. in U.S. Pat. No. 5,415,786, and by Farmer in U.S. Pat. No. 5,425,858, the entire disclosure of each of which is hereby incorporated herein by reference for all purposes.

In accordance with certain examples, in passing the feed water to the first stage 110, about 90% of the initial levels of salts in the feed water may be removed. In the case of feed water having 150 mg/L CaCO₃ and 100 mg/L SiO₂, discharge from the first stage would include about 15 mg/L CaCO₃ and about 10 mg/L SiO₂. The discharge from the first stage 110 may then be passed to the second stage 120 to remove additional species in the water. In embodiments where the second stage 120 is a reverse osmosis stage, about 95-98% of the remaining species may be removed. For example, where the influent stream to the RO includes about 15 mg/L CaCO₃ and about 10 mg/L SiO₂, the RO may be effective to remove about 95-98% of the species to provide a discharge to the third stage that includes about 200-750 μg/L CaCO₃ and about 200-500 μg/L SiO₂. The discharge from the second stage 120 may then be passed to the third stage 130 to remove additional species in the fluid. For example, where the third stage 130 includes an electrochemical device such as an electrodeionization device or a continuous deionization device, the third stage 130 may remove a sufficient amount of the remaining ionic species to provide a discharge having a specific resistance of greater than 1 Megohm-cm. In certain examples, the entire process of treating the water to provide a discharge having a specific resistance of greater than 1 Megohm-cm also provides a water recovery rate of at least 90% by volume or more.

In accordance with certain examples, the systems disclosed herein may also include one or more additional stages to further increase water purity and/or to increase the water recovery rate. For example and referring to FIG. 1B, a system 150 may include those components described in reference to FIG. 1A, but may also be configured such that reject or concentrate from the third stage 130 is fed back to the second stage 120, as shown by arrow 160 in FIG. 1B. By providing reject or concentrate from the third stage 130 back to the second stage 120, the water recovery rate may be further increased. In some configurations, the concentrate may be passed back to the second stage 120 such that there is zero waste from the third stage 130. Such systems may be referred to in certain instances as zero discharge systems.

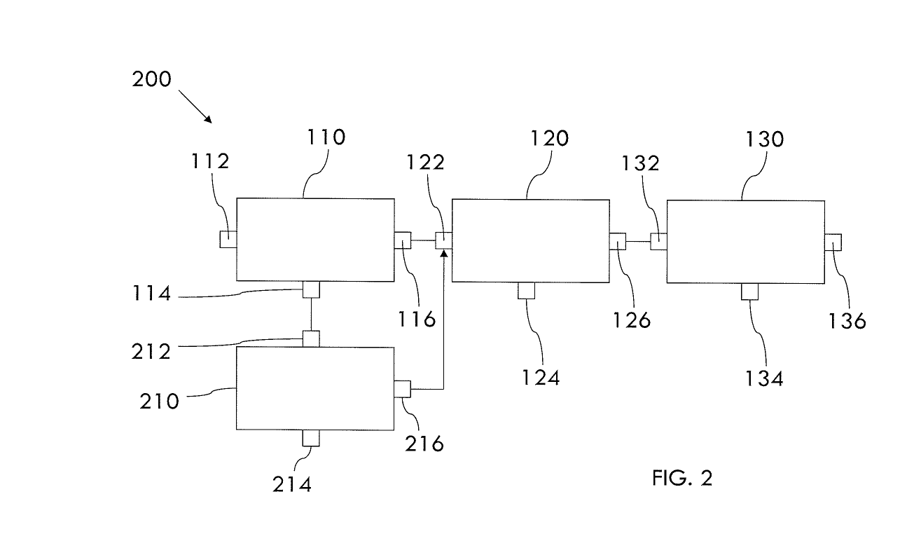

In accordance with certain examples, the systems disclosed herein may include one or more additional stages fluidly connected to one or more of the first, second and third stages. An example of an additional stage fluidically coupled to the first stage is shown in FIG. 2. The system 200 is similar to that described in reference to FIG. 1A and also includes an additional stage 210 comprising a filtration device and fluidically coupled to the first stage 110. The additional stage 210 includes an inlet 212, a first outlet 214 and a second outlet 216. The additional stage 210 may receive reject from the first stage 110 and is effective to pass permeate to the second stage 120. For example, the second outlet 216 may pass permeate from the filtration device of the additional stage 210 to the inlet 122 of the second stage 120 to further increase water recovery and/or to treat the water further. As discussed further below, one or more valves may connect the first stage 110 to the additional stage 210 to control fluid flow from the first stage 110 to the additional stage 210. The valves may be actuated using a controller, such as the illustrative controller described below.

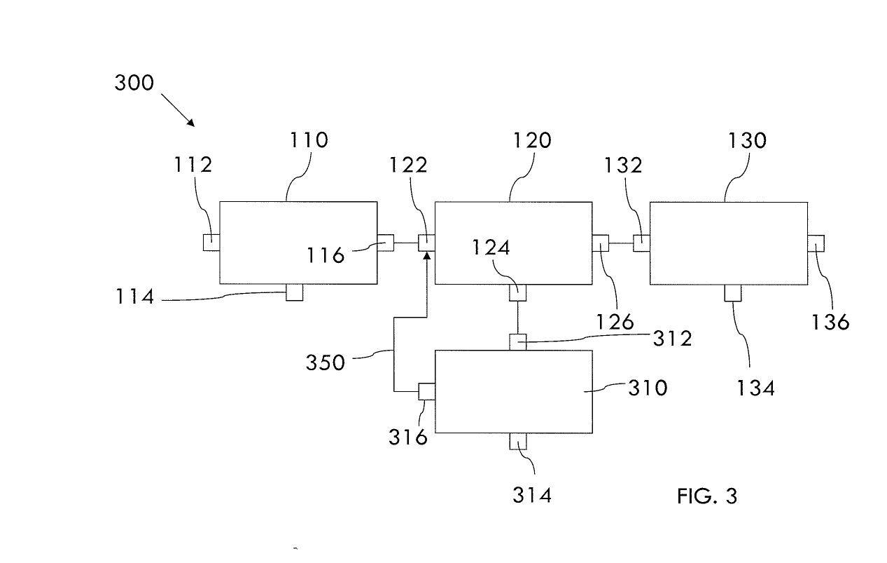

In accordance with certain examples, a system comprising at least one additional stage fluidically coupled to the second stage is provided. Referring to FIG. 3, a system 300 includes a first stage 110, a second stage 120 and a third stage 130, as discussed above in reference to FIG. 1A. The system 300 also includes an additional stage 310 fluidly connected to the second stage 120 through the outlet 124 of the second stage 120 and the inlet 312 of the additional stage 310. Concentrate from the second stage 120 may pass to the additional stage 310 for further treatment and/or for recovery of water to increase the overall water recovery rate of the system 300. The additional stage 310 may include one or more of a filtration device or a reverse osmosis device. In embodiments where the additional stage 310 is a reverse osmosis device, the stage 310 may pass permeate back to the second stage 120, as shown by arrow 350, through outlet 316 of the additional stage 310 to inlet 122 of the second stage 120. Reject from the additional stage 310 may be discharged through an outlet 314. As discussed further below, one or more valves may connect the second stage 120 to the additional stage 310 to control fluid flow from the second stage 120 to the additional stage 310. The valves may be actuated using a controller, such as the illustrative controller described below.

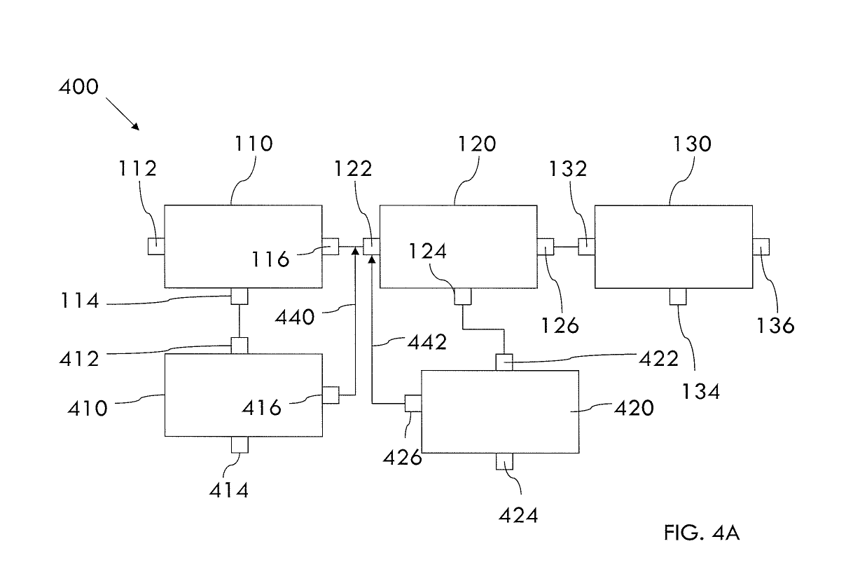

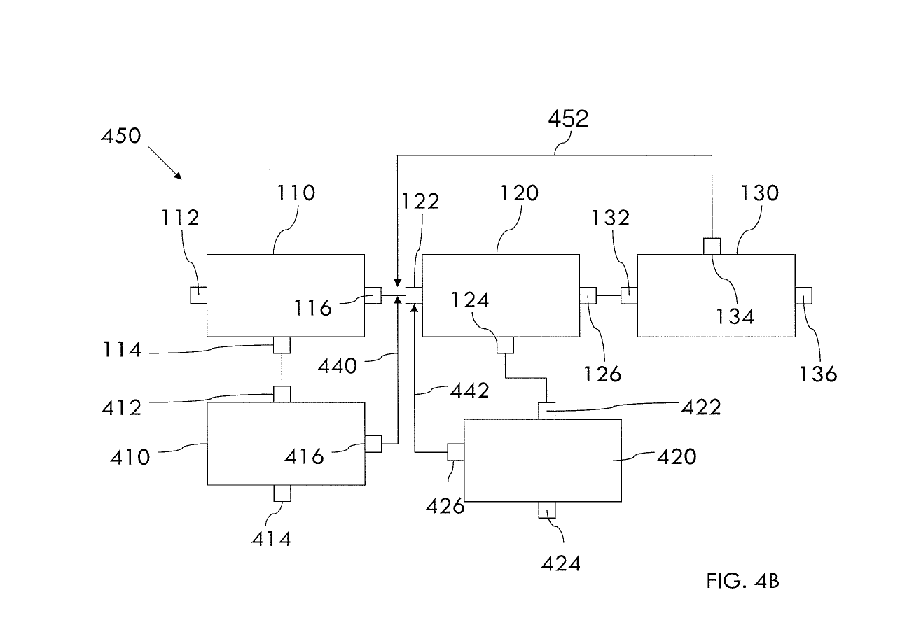

In accordance with certain examples, a system comprising two or more additional stages is disclosed. Such additional stages may be fluidically coupled to at least two of the first stage, the second stage and the third stage. For example and referring to FIG. 4A, a system 400 includes a first stage 110, a second stage 120 and a third stage 130, as discussed above in reference to FIG. 1A. The system 400 also includes a fourth stage 410 and a fifth stage 420. The fourth stage 410 may be fluidically coupled to the first stage 110 through outlet 114 of the first stage 110 and inlet 412 of the fourth stage 410. The fourth stage also includes an outlet 414 for discharging reject from the fourth stage and an outlet 416 for passing permeate to the second stage 120. In certain examples, the fourth stage may include a filtration device or a reverse osmosis device, or both, such that reject from the first stage 110 may be further treated and/or water recovery may be increased by using the fourth stage 410. For example, permeate from the fourth stage 410 may be passed to the second stage 120 through outlet 416 and into inlet 122 as shown by arrow 440. Similarly, fifth stage 420 may be fluidically coupled to the second stage 120 through outlet 122 of the second stage and inlet 422 of the fifth stage 420. The fifth stage also includes an outlet 424 for discharging reject and an outlet 426 for passing permeate to the second stage 120. In certain examples, the fifth stage may include a filtration device or a reverse osmosis device, or both, such that reject from the second stage 120 may be further treated and/or water recovery may be increased by using the fifth stage 420. For example, permeate from the fifth stage 420 may be passed back to the second stage 120 through outlet 426 and into inlet 122 as shown by arrow 442. As discussed further below, one or more valves may connect the fourth stage 410 and the fifth stage 420 to the other stages to control fluid flow to the fourth and fifth stages. The valves may be actuated using a controller, such as the illustrative controller described below.

In certain examples, the system comprising two or more additional stages may also include a recycling step such that concentrate from the third stage may be fed back to the second stage to further increase water recovery. An example of this configuration is shown in FIG. 4B. The system 450 is similar to the system described in reference to FIG. 4A and also includes a fluid coupling between the outlet 134 of the third stage 130 and the inlet 122 of the second stage 120. While not shown, outlet 134 may be coupled to the inlet 412 of the fourth stage 410 or the inlet 422 of the fifth stage 420 instead of the inlet 122. In the alternative, the fluid discharged from the outlet 134 may be split such that a portion of the fluid is passed to at least two of the second stage 120, the fourth stage 410 and the fifth stage 420 for further treatment and/or for further recovery of water. Additional configurations employing recycling of reject from the third stage will be readily selected by the person of ordinary skill in the art, given the benefit of this disclosure.

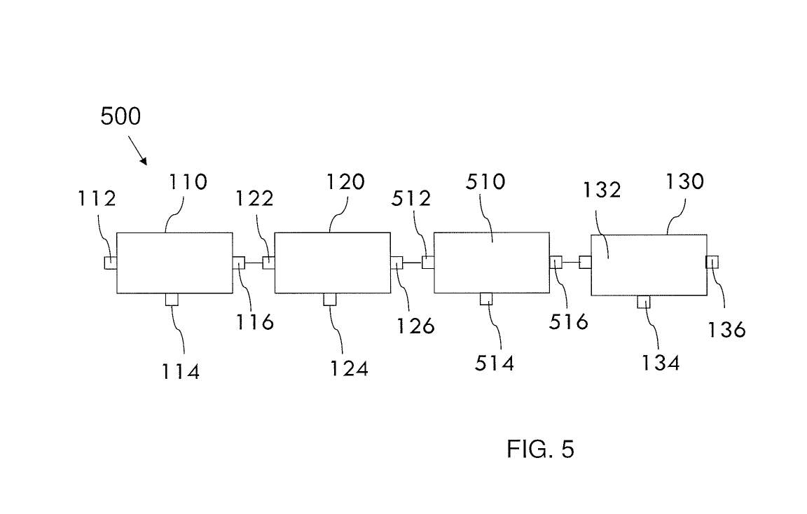

In accordance with certain examples, a system comprising an intervening stage between either the first stage 110 and the second stage 120 or the second stage 120 and the third stage 130, or both, is disclosed. An example of this configuration where an intervening stage is present between the second stage 120 and the third stage 130 is shown in FIG. 5. The system 500 includes a first stage 110, a second stage 120 and a third stage 130 as described above in reference to FIG. 1A. An additional stage 510 is between the second stage 120 and the third stage 130. The additional stage 510 is fluidically coupled to outlet 126 of second stage 120 through an inlet 512 and is also fluidically coupled to inlet 132 of the third stage 130 through an outlet 516. Reject from the additional stage 510 may be discharged through an outlet 514 and may go to waste or may be recycled using configurations similar to, or the same as, those described herein to increase water recovery rates and/or to increase the purity of the water. In certain examples, the first stage 110 of the system 500 may include a filtration device, the second stage 120 of the system 500 may include a reverse osmosis device and the third stage 130 of the system 500 may include an electrochemical device. In some examples, the additional stage 510 may be a filtration device, a reverse osmosis device or a electrochemical device, such as, for example, the illustrative filtration devices and systems, reverse osmosis devices and systems or electrochemical device and systems described herein.

In accordance with certain examples, the systems disclosed herein may include one or more pre-treatment operations or treatment operations between the various stages in the systems. Such pre-treatment operations include, but are not limited to, aeration, pH adjustment, precipitation, dechlorination, clarification, filtration, sterilization and the like. Pre-treatment may be accomplished, for example, by fluidly connecting a suitable device to one or more of the stages or one or more of the fluid passages connecting the various stages. For example, a reservoir comprising a basic solution may be fluidly connected to the inlet of the first stage to adjust the pH to alkaline conditions. As discussed further below, the pre-treatment devices may include one or more valves that may be actuated to either permit treatment or prevent treatment depending on the conditions of the feed water.

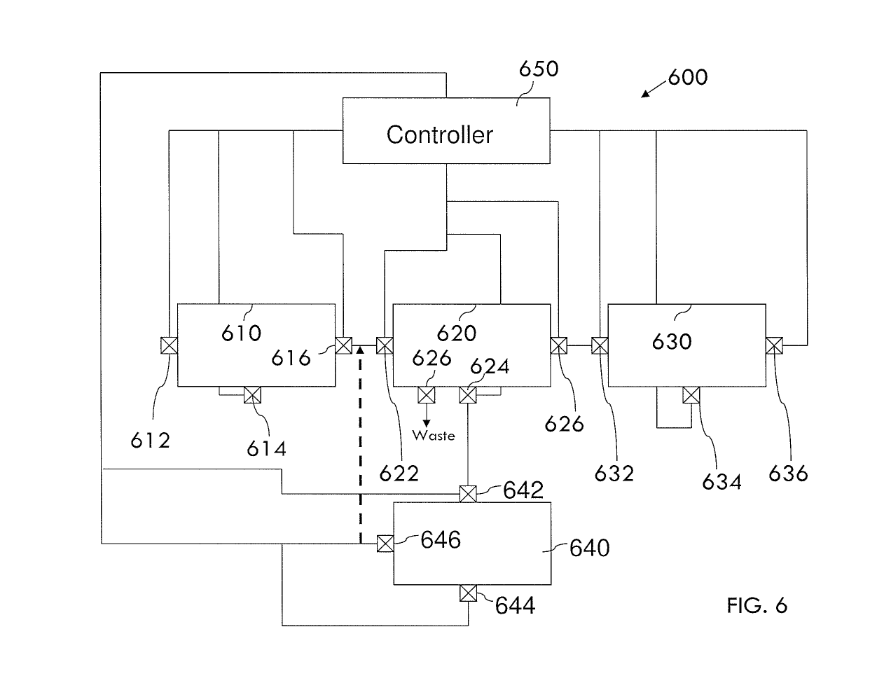

In accordance with certain examples, a controller for use in the methods and systems disclosed herein is provided. The controller may be electrically coupled to one or more valves in the systems and/or one or more sensors. An example of a system comprising a controller is shown in FIG. 6. The system 600 includes a first stage 610 fluidically coupled to a second stage 620 through an outlet 616 of the first stage 610 and an inlet 622 of the second stage 620. The second stage 620 is fluidically coupled to a third stage 630 through an outlet 626 of the second stage 620 and an inlet 632 of the third stage 630. The second stage 620 is also fluidically coupled to a fourth stage 640 through an outlet 624 of the second stage 620 and an inlet 642 of the fourth stage. The first stage 610 also includes an outlet 614 to discharge reject or waste. The second stage 620 also includes an outlet 624 to discharge reject or waste. The third stage 630 includes an outlet 636 to discharge treated water and an outlet 634 to discharge reject or concentrate. In the system 600, each of the inlets and outlets of the four stages may include a valve electrically coupled to a controller 650 as shown in FIG. 6. The controller 650 may be configured to send and receive signals to open or close the valves in response to one or more measurements received from a sensor (not shown). For example, in the instance where the water recovery rate is below 90% by volume, the controller 650 may send a signal to close outlet 626 and open the valve in outlet 624 such that reject from the second stage may be provided to the fourth stage for further water recovery. In certain examples and as shown in FIG. 6, each outlet and inlet of each stage may include a valve that may be actuated by the controller 650, whereas in other examples only selected inlets, outlets or both may include a valve. The valve may be electrically coupled to the controller through a lead or interconnect such that the valve can receive a signal from the controller. In certain examples, the first stage 610 of the system may comprise a microfiltration device, the second stage 620 and the fourth stage 640 may each comprise a reverse osmosis device and the third stage 630 may comprise an electrochemical device.

In accordance with certain examples, a controller for use with the systems and methods disclosed herein may be configured to receive inputs from one or more sensors, to actuate one or more valves in the system, to supply power to the electrochemical device or other operations. The exact nature and type of sensors may vary depending on the measurements or parameters desired at a particular area or at a particular stage of the system. For example, the sensors may include one or more of a spectrometer, a nephelometer, a composition analyzer, a pH sensor, a temperature sensor, a pressure sensor, and a flow rate sensor. One or more of the sensors may be configured to measure the conductivity or resistivity of the water. In certain examples, there may be a first sensor upstream of the first stage to monitor the volume of water provided to the system and a second sensor downstream of the third stage to monitor the volume of water discharged from the system. These two sensed volumes may be used, for example, to calculate the water recovery rate of the system. In some examples, the system may include a plurality of sensors, which may be the same or may be different types of sensors, at selected sites in the system to provide a desired measurement.

In certain examples, the controller may be implemented using, at least in part, a computer system. The computer system may be, for example, general-purpose computers such as those based on Unix, Intel PENTIUM-type processor, Motorola PowerPC, Sun UltraSPARC, Hewlett-Packard PA-RISC processors, or any other type of processor. It should be appreciated that one or more of any type computer system may be used according to various embodiments of the technology. Further, the system may be located on a single computer or may be distributed among a plurality of computers attached by a communications network. A general-purpose computer system according to one embodiment may be configured to perform any of the described functions including but not limited to: conductivity measurements, water recovery rate monitoring, pH measurements, pressure measurements, flow rate measurements and the like. It should be appreciated that the system may perform other functions, including network communication, and the technology is not limited to having any particular function or set of functions.

In certain embodiments, the controller may include one or more algorithms executing in a general-purpose computer system. The computer system may include a processor coupled to one or more memory devices, such as a disk drive, memory, or other device for storing data. Memory is typically used for storing programs and data during operation of the computer system. Components of computer system may be coupled by an interconnection mechanism, which may include, for example, one or more busses (e.g., between components that are integrated within a same machine) and/or a network (e.g., between components that reside on separate discrete machines). The interconnection mechanism is operative to enable communications (e.g., data, instructions) to be exchanged between system components of computer system. The computer system typically is electrically coupled to one or more sensors and/or one or more valves such that electrical signals may be provided from the water treatment system to the computer system for storage and/or processing.

In certain examples, the computer system may also include one or more input devices, for example, a keyboard, mouse, trackball, microphone, touch screen, and one or more output devices, for example, a printing device, display screen, speaker or the like. In addition, the computer system may contain one or more interfaces that connect the computer system to a communication network (in addition or as an alternative to the interconnection mechanism. The storage system typically includes a computer readable and writeable nonvolatile recording medium in which signals are stored that define a program to be executed by the processor or information stored on or in the medium to be processed by the program. For example, the water recovery rate may stored in the medium. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in storage system or in a memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or a storage system.

The computer system may also include specially-programmed, special-purpose hardware, for example, an application-specific integrated circuit (ASIC). Aspects of the technology may be implemented in software, hardware or firmware, or any combination thereof. Further, such methods, acts, systems, system elements and components thereof may be implemented as part of the computer system described above or as an independent component. Although a computer system is described by way of example as one type of computer system upon which various aspects of the technology may be practiced, it should be appreciated that aspects are not limited to being implemented on any particular type of computer system. Various aspects may be practiced on one or more computers having a different architecture or components than those described herein. The computer system may be a general-purpose computer system that is programmable using a high-level computer programming language. The computer system may be also implemented using specially programmed, special purpose hardware. The processor is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME), Windows XP or Windows Vista operating systems available from the Microsoft Corporation, MAC OS System X operating system available from Apple Computer, the Solaris operating system available from Sun Microsystems, or UNIX or Linux operating systems available from various sources. Many other operating systems may be used.

The processor and operating system together define a computer platform for which application programs in high-level programming languages may be written. It should be understood that the technology is not limited to a particular computer system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate computer systems could also be used.

In certain examples, the hardware or software may be configured to implement cognitive architecture, neural networks or other suitable implementations. For example, a lookup table may be linked to the system to provide access to acceptable treatment parameters, e.g., resistivity values, conductivity values, pH values and the like. One or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP).

It should also be appreciated that the technology is not limited to executing on any particular system or group of systems. Also, it should be appreciated that the technology is not limited to any particular distributed architecture, network, or communication protocol. Various embodiments may be programmed using an object-oriented programming language, such as SmallTalk, Basic, Java, C++, Ada, or C# (C-Sharp). Other object-oriented programming languages may also be used. Alternatively, functional, scripting, and/or logical programming languages may be used. Various aspects may be implemented in a non-programmed environment (e.g., documents created in HTML, XML or other format that, when viewed in a window of a browser program, render aspects of a graphical-user interface (GUI) or perform other functions).

Various aspects may be implemented as programmed or non-programmed elements, or any combination thereof. In certain examples, a user interface may be provided such that a user may enter a desired flow rate, a desired pH, a desired water recovery rate or the like. For example, in instances where a user desires a certain water recovery rate, the user can enter the desired rate into the computer system and the controller may function to open selected valves for recycling of reject from the first stage, second stage or third stage to obtain the desired water recovery rate or the controller may adjust the operating parameters of the individual stages to increase the overall water recovery rate. The user interface may also include fields for inputting user notes or the like. Other features for inclusion in a user interface will be readily selected by the person of ordinary skill in the art, given the benefit of this disclosure.

In certain examples, the controller may be configured to reverse the polarity of the electrochemical device to assist in cleaning of the electrochemical device. A suitable controller is described by, for example, Freydina et al. in published U.S. Patent Application No. 20060157422, the entire disclosure of which is hereby incorporated herein by reference for all purposes. Additional suitable controllers will be readily selected by the person of ordinary skill in the art, given the benefit of this disclosure.

In accordance with certain examples, the systems and methods disclosed herein may also include one or more pumps, aerators, or other mechanical devices to control flow rate, oxygen levels, pressure levels and the like in the system.

In accordance with certain examples, a system for treating water is disclosed. In certain examples, the system comprises a first device constructed and arranged to remove at least 90% of calcium carbonate from feed water to provide concentrate. The system may also include a second device fluidically coupled to the first device, the second device constructed and arranged to remove at least 95% of calcium carbonate from the concentrate to provide partially treated water. The system may also include a third device fluidically coupled to the second device, the third device constructed and arranged to remove a sufficient amount of remaining ionic species in the partially treated water to provide treated water having a specific resistance greater than or equal to 1 Megohm-cm. In some examples, the first device may be, or may include, an ultrafiltration device, a microfiltration device, a nanofiltration device, and combinations thereof. In certain examples, the second device may be, or may include, a reverse osmosis device or a reverse osmosis device fluidically coupled to another reverse osmosis device. In some examples, the third device may be, or may include, an electrochemical device selected from the group consisting of an electrodeionization device, a continuous electrodeionization device, an electrodialysis device, an electrodialysis reversal capacitive deionization device, a reversible continuous electrodeionization device, and combinations thereof.

In accordance with certain examples, the systems disclosed herein may be part of a larger system. For example, the water treatment system may be part of a larger system that provides treated water to a point of use. In some examples, the water treatment systems disclosed herein may be one part of a cooling tower system that comprises a cooling tower fluidically coupled to the water treatment system. In other examples, the water treatment system may be part of a larger system that comprises a water reservoir such as, for example, a well, body of water (e.g., a pond, river, lake, ocean, etc.), that is fluidically coupled to the water treatment system. Such systems may be used, for example, where desalination of water is desired. In other examples, the water treatment system may be part of a larger system that comprises a painting system, a system for pharmaceutical testing, a power system and the like. Additional systems that include one or more of the water treatment systems disclosed herein will be readily selected by the person of ordinary skill in the art, given the benefit of this disclosure.

Certain examples of the systems disclosed herein may be modularized or pre-packaged such that a user couples feed water to the system and couples a site for treated water discharge. All internal connections may be performed prior to packaging to facilitate ease of use at a site.

In accordance with certain examples, a method of treating water is also disclosed. In certain examples, the method comprises providing filtered water by reducing an amount of species in feed water by at least 90% using a first stage comprising a filtration device. The method may also include providing partially treated water by reducing an amount of species in the filtered water by at least 95% using a second stage fluidically coupled to the first stage and comprising a reverse osmosis device. The method may further include providing treated water having a specific resistance of greater than or equal to 1 Megohm-cm by removing a sufficient amount of remaining ionic species from the partially treated water using a third stage fluidically coupled to the second stage.

In some examples, the treated water may be provided at a water recovery rate greater than 90%. In certain examples, the water recovery rate of greater than 90% may be obtained without recycling reject from the second stage. In other examples, the treated water may be provided without precipitation of calcium carbonate in the feed water with a pre-treatment step. In some examples, the method may also comprise recovering water from reject of the second stage by passing the reject to an additional stage fluidically coupled to the second stage. The additional stage may comprise a reverse osmosis device configured to receive the reject from the second stage and to pass permeate from the additional stage back to the second stage. In certain examples, the method may also comprise recovering water from reject of the third stage by passing the reject back to the second stage. In certain examples, the method may also include recovering water from reject of the first stage by passing the reject to an additional stage fluidically coupled to the first stage. The additional stage may comprise a filtration device configured to receive the reject from the first stage and to pass permeate from the additional stage back to the first stage. In some examples, the method may also comprise recovering water from reject of the first stage by passing the reject to an additional stage fluidically coupled to the first stage. The additional stage may comprise a filtration device configured to receive the reject from the first stage and to pass permeate from the additional stage to the second stage.

In some examples, the filtration device of the first stage may be an ultrafiltration device, a microfiltration device, a nanofiltration device or combinations thereof. In other examples, the reverse osmosis device of the second stage may be configured as a high efficiency reverse osmosis device. In some examples, the electrochemical device of the third stage may be an electrodeionization device, a continuous electrodeionization device, an electrodialysis device, an electrodialysis reversal capacitive deionization device, a reversible continuous electrodeionization device, or combinations thereof. In yet other examples, the water may be further treated by disinfecting the treated water with ultraviolet light. In certain examples, the method may use an additional stage between the second stage and the third stage. The additional stage may be fluidically coupled to the second stage and the third stage and comprise a reverse osmosis device.

In accordance with certain examples, a method of treating hard water that provides at least a 90% water recovery rate by volume is disclosed. In certain examples, the method comprises passing the hard water to a first stage comprising a filtration device configured to provide filtered water. In other examples, the method also comprises passing filtered water from the first stage to a second stage fluidically coupled to the first stage. The second stage may comprise a reverse osmosis device configured to provide partially treated water. In some examples, the method may also comprise passing the partially treated water to a third stage fluidically coupled to the second stage, the third stage comprising an electrochemical device configured to remove a sufficient amount of remaining ionic species from the partially treated water to provide treated water having a specific resistance greater than or equal to 1 Megohm-cm.

In certain examples, the method may also include passing reject from the second stage to an additional stage fluidically coupled to the second stage. The additional stage may comprise a reverse osmosis device configured to receive the reject from the second stage and to recover water for passing back to the second stage. In some examples, the method may also comprise providing concentrate from the third stage to the second stage for further treatment. In certain examples, the method may also comprise providing reject from the first stage to an additional stage comprising a filtration device. The additional stage may be configured to recover water for passing to the first stage or to the second stage or both. In some embodiments, the method may also comprise an additional stage between the second stage and the third stage. The additional stage may be fluidically coupled to the second stage and the third stage and comprise a reverse osmosis device.

In certain examples, the filtration device of the first stage may be an ultrafiltration device, a microfiltration device, a nanofiltration device or combinations thereof. In some examples, the reverse osmosis device of the second stage may be configured as a high efficiency reverse osmosis device. In yet other examples, the electrochemical device of the third stage may be an electrodeionization device, a continuous electrodeionization device, an electrodialysis device, an electrodialysis reversal capacitive deionization device, a reversible continuous electrodeionization device or combinations thereof.

In accordance with certain examples, a method of facilitating treatment of hard water to provide treated water having a specific resistance of greater than or equal to 1 Megohm-cm at a water recovery rate of at least 90% by volume is disclosed. In certain examples, the method comprises providing a system comprising a first stage configured to receive the hard water and comprising a filtration device configured to provide filtered water. The system may also comprise a second stage fluidically coupled to the first stage and comprising a reverse osmosis device configured to provide partially treated water. The system may also comprise a third stage fluidically coupled to the second stage and configured to remove a sufficient amount of remaining ionic species from the partially treated water to provide the treated water having a specific resistance greater than or equal to 1 Megohm-cm at a water recovery rate of at least 90% by volume.

Certain prophetic examples are described below to illustrate further some of the novel features, aspects and examples of the technology described herein.

### EXAMPLE 1

Cooling tower blow-down water may include 500 mg/L CaCO₃ and 120 mg/L SiO₂. The water may be fed to a first stage comprising a microfiltration device to remove about 90% of the species in the water. The first stage may pass water having about 50 mg/L CaCO₃ and 10 g/L SiO₂ to a second stage. The second stage comprises a reverse osmosis device and may remove about 98% of remaining species in the water to provide water having about 1 mg/L CaCO₃ and 200 μg/L SiO₂. This water may be passed to a third stage comprising a continuous deionization device to remove substantially all remaining ionic species and provide water with a specific resistance of at least 1 Megohm-cm. The water recovery rate may be 90% by volume or more.

### EXAMPLE 2

Cooling tower blow-down water may include 500 mg/L CaCO₃ and 120 mg/L SiO₂. The water may be fed to a first stage comprising a microfiltration device to remove about 90% of the species in the water. The first stage may pass water having about 50 mg/L CaCO₃ and 10 g/L SiO₂ to a second stage. The second stage comprises a reverse osmosis device and may remove about 98% of remaining species in the water to provide water having about 1 mg/L CaCO₃ and 200 g/L SiO₂. This water may be passed to a third stage comprising a continuous deionization device to remove substantially all remaining ionic species and provide water with a specific resistance of at least 1 Megohm-cm. Reject from the second stage may be passed to an additional stage comprising a reverse osmosis device. The additional stage further purifies the reject and recycles water back to the second stage to increase the water recovery rate to 90% by volume or more. The additional stage may also receive concentrate from the third stage to increase the water recovery rate even further.

### EXAMPLE 3

Feed water having about 200 mg/L CaCO₃ may be fed to a first stage comprising a microfiltration device that includes a KYNAR® membrane. At least 90% of the CaCO₃ is removed using the microfiltration device leaving no more than 20 mg/L CaCO₃ in the filtrate. The filtrate may then be passed to a second stage comprising a reverse osmosis device. The reverse osmosis device may remove at least 95% of the remaining CaCO₃ leaving about 1 mg/L CaCO₃ in the permeate. The second stage is fluidically coupled to a third stage comprising an electrodeionization device. The electrodeionization device may remove a sufficient amount of the remaining CaCO₃ to provide water having a specific resistance of at least 1 Megohm-cm. The water recovery rate may be 90% by volume or more.

### EXAMPLE 4

Feed water having about 300 mg/L CaCO₃ and 100 mg/L SiO₂ may be fed to a first stage comprising a microfiltration device that includes a KYNAR® membrane. At least 90% of the CaCO₃ and the SiO₂ are removed using the microfiltration device leaving no more than 30 mg/L CaCO₃ and no more than 10 mg/L SiO₂ in the filtrate. The filtrate may then be passed to a second stage comprising a reverse osmosis device. The reverse osmosis device may remove at least 95% of the remaining CaCO₃ and SiO₂ leaving about 1 mg/L CaCO₃ and about 500 μg/L SiO₂ in the permeate. The second stage is fluidically coupled to a third stage comprising an electrochemical device. The electrochemical device may remove a sufficient amount of the remaining CaCO₃ to provide water having a specific resistance of at least 1 Megohm-cm. A fourth stage is included and fluidly connected to the second stage to receive reject from the second stage and to recover additional water in the reject. A fifth stage is also included and fluidly connected to the third stage to receive concentrate from the third stage and to recover additional water in the concentrate for passing back to the second stage or the third stage. The recovered water in the fourth and fifth stages may increase the overall water recovery rate to 90% by volume or more.

When introducing elements of the aspects, embodiments and examples disclosed herein, the articles “a, “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative features, aspects, examples and embodiments are possible. Should the meaning of any terms used in the patents and patent applications incorporated herein by reference conflict with the meaning of the terms used herein, the meaning of the terms used herein are intended to be controlling.

What is claimed is:

1. A method comprising:
providing filtered water by reducing an amount of species in feed water by at least 90% using a first stage comprising a microfiltration device;
providing partially treated water by reducing an amount of species in the filtered water by at least 95% using a second stage fluidically coupled to the first stage and comprising a reverse osmosis device; and
providing treated water having a specific resistance of greater than or equal to 1 Megohm-cm by removing a sufficient amount of remaining ionic species from the partially treated water using a third stage fluidically coupled to the second stage and comprising an electrochemical device, wherein the treated water is provided at a water recovery rate of at least 90% by volume.

2. The method of claim 1, in which the water recovery rate of at least 90% by volume is provided without recycling reject from the second stage.

3. The method of claim 1, in which the treated water is provided without precipitation of calcium carbonate in the feed water.

4. The method of claim 1, further comprising recovering water from reject of the second stage by passing the reject to an additional stage fluidically coupled to the second stage, the additional stage comprising a reverse osmosis device configured to receive the reject from the second stage and to pass permeate from the additional stage to the second stage.

5. The method of claim 1, further comprising recovering water from reject of the third stage by passing the reject back to the second stage.

6. The method of claim 1, further comprising recovering water from reject of the first stage by passing the reject to an additional stage fluidically coupled to the first stage, the additional stage comprising a filtration device configured to receive the reject from the first stage and to pass permeate from the additional stage back to the first stage.

7. The method of claim 6, in which the filtration device of the additional stage is an ultrafiltration device, a microfiltration device or a nanofiltration device.

8. The method of claim 1, further comprising recovering water from reject of the first stage by passing the reject to an additional stage fluidically coupled to the first stage, the additional stage comprising a filtration device configured to receive the reject from the first stage and to pass permeate from the additional stage to the second stage.

9. The method of claim 8, in which the filtration device of the additional stage is an ultrafiltration device, a microfiltration device or a nanofiltration device.

10. The method of claim 1, in which the reverse osmosis device of the second stage is configured as a high efficiency reverse osmosis device.

11. The method of claim 1, in which the electrochemical device of the third stage is an electrodeionization device, a continuous electrodeionization device, an electrodialysis device, an electrodialysis reversal capacitive deionization device, or a reversible continuous electrodeionization device.

12. The method of claim 1, further comprising disinfecting the treated water with ultraviolet light.

13. The method of claim 1, further comprising an additional stage between the second stage and the third stage, the additional stage fluidically coupled to the second stage and the third stage and comprising a reverse osmosis device.

14. A method of treating feed water comprising calcium carbonate and silicon dioxide, the method comprising:
passing the hard water to a first stage comprising a microfiltration device configured to provide filtered water;
passing the filtered water from the first stage to a second stage fluidically coupled to the first stage, the second stage comprising a reverse osmosis device configured to provide partially treated water; and
passing the partially treated water to a third stage fluidically coupled to the second stage, the third stage comprising an electrochemical device configured to remove a sufficient amount of remaining ionic species from the partially treated water to provide treated water having a specific resistance greater than or equal to 1 Megohm-cm, wherein the treated water is provided at water recovery rate of at least 90% by volume.

15. The method of claim 14, further comprising passing reject from the second stage to an additional stage fluidically coupled to the second stage, the additional stage comprising a reverse osmosis device configured to receive the reject from the second stage and to recover water for passing to the second stage.

16. The method of claim 14, further comprising providing reject from the third stage to the second stage for further treatment.

17. The method of claim 14, further comprising providing reject from the first stage to an additional stage comprising a filtration device, the additional stage configured to recover water for passing to the second stage.

18. The method of claim 14, further comprising an additional stage between the second stage and the third stage, the additional stage fluidically coupled to the second stage and the third stage and comprising a reverse osmosis device.

19. The method of claim 14, in which the filtration device of the additional stage is an ultrafiltration device, a microfiltration device or a nanofiltration device.

20. The method of claim 14, in which the reverse osmosis device of the second stage is configured as a high efficiency reverse osmosis device.

21. The method of claim 14, in which the electrochemical device of the third stage is an electrodeionization device, a continuous electrodeionization device, an electrodialysis device, an electrodialysis reversal capacitive deionization device, or a reversible continuous electrodeionization device.

22. A system to provide treated water from feed water, the system comprising:
a first stage comprising a microfiltration device effective to remove at least 90% of calcium carbonate from the feed water to provide filtered water;
a second stage fluidically coupled to the first stage and comprising a reverse osmosis device effective to remove at least 95% of species remaining in the filtered water to provide partially treated water; and
a third stage fluidically coupled to the second stage and comprising an electrochemical device effective to remove a sufficient amount of remaining ionic material to provide treated water having a specific resistance of greater than or equal to 1 Megohm-cm, wherein the treated water is provided at a water recovery rate of at least 90% by volume.

23. The system of claim 22, in which the microfiltration device comprises a ½ inch module, a ¾ inch module, or a 1 inch module.

24. The system of claim 22, further comprising an additional stage fluidically coupled to the first stage and configured to receive reject from the first stage and to recover water from the reject and pass the recovered water to the second stage.

25. The system of claim 22, further comprising an additional stage fluidically coupled to the second stage and comprising a reverse osmosis device configured to receive reject from the second stage and pass permeate from the additional stage back to the second stage.

26. The system of claim 22, in which the third stage is configured to pass reject from the third stage back to the second stage for further purification.

27. The system of claim 24, in which the additional stage comprises an ultrafiltration device, a microfiltration device, a nanofiltration device or a reverse osmosis device.

28. The system of claim 22, in which the reverse osmosis device of the second stage is configured as a high efficiency reverse osmosis device.

29. The system of claim 22, in which the electrochemical device of the third stage is an electrodeionization device, a continuous electrodeionization device, an electrodialysis device, an electrodialysis reversal capacitive deionization device, or a reversible continuous electrodeionization device.

30. The system of claim 22, further comprising an ultraviolet light source for disinfecting the treated water.

31. The system of claim 22, in which the first stage is configured to remove at least 90% of silicon dioxide in the feed water, the second stage is configured to remove at least 95% of silicon dioxide in the filtered water.

32. The system of claim 22, in which the reverse osmosis device is a high efficiency reverse osmosis device configured to remove at least 95% of species in a fluid passed to the reverse osmosis device.

33. The system of claim 22 further comprising at least one additional stage between the second stage and the third stage and comprising a reverse osmosis device.

34. The system of claim 22, in which the system is configured to receive feed water comprising a calcium carbonate level of about 500 mg/L and a silicon dioxide level of about 120 mg/L. and to provide the treated water having a specific resistance of greater than or equal to 1 Megohm-cm at a water recovery rate of at least 90% by volume.

35. The system of claim 22, in which the system is fluidically coupled to a water reservoir, a power system, a painting system, and a system for pharmaceutical testing.

36. The system of claim 22, further comprising a controller electrically coupled to one or more of the first stage, the second stage and the third stage.

37. The system of claim 36, in which the controller is electrically coupled to at least one sensor in the first stage, the second stage or the third stage.

38. The system of claim 37, in which the controller is operative to sense a volume of the feed water passed to the first stage and a volume of the treated water discharged from the third stage to determine the water recovery rate.

39. The system of claim 37, in which the sensor is fluidically coupled to an outlet of the third stage and is operative to measure specific resistance of the treated water discharged from the third stage.

40. A system comprising
a first device constructed and arranged to remove at least 90% of calcium carbonate from feed water to provide concentrate;
a second device fluidically coupled to the first device, the second device constructed and arranged to remove at least 95% of calcium carbonate from the concentrate to provide partially treated water; and
a third device fluidically coupled to the second device, the third device constructed and arranged to remove a sufficient amount of remaining ionic species in the partially treated water to provide treated water having a specific resistance greater than or equal to 1 Megohm-cm, wherein the treated water is provided at a water recovery rate of at least 90% by volume.

41. The system of claim 40, in which the first device is an ultrafiltration device, microfiltration device, a nanofiltration device, and combinations thereof.

42. The system of claim 41, in which the second device is a reverse osmosis device or a reverse osmosis device fluidically coupled to a second reverse osmosis device.

43. The system of claim 42, in which the third device is an electrochemical device selected from the group consisting of an electrodeionization device, a continuous electrodeionization device, an electrodialysis device, an electrodialysis reversal capacitive deionization device, a reversible continuous electrodeionization device, and combinations thereof.

44. The system of claim 40, further comprising a controller electrically coupled to one or more of the first stage, the second stage and the third stage.

45. The system of claim 44, in which the controller is electrically coupled to at least one sensor in the first stage, the second stage or the third stage.

46. The system of claim 45, in which the controller is operative to receive a sensed volume of the feed water passed to the first stage and a sensed volume of the treated water discharged from the third stage to determine the water recovery rate.

47. The system of claim 45, in which the sensor is fluidically coupled to an outlet of the third device and is operative to measure specific resistance of the treated water discharged from the third device.

48. A method of facilitating treatment of hard water comprising calcium carbonate and silicon dioxide to provide treated water having a specific resistance of greater than or equal to 1 Megohm-cm at a water recovery rate of at least 90% by volume, the method comprising providing a system comprising a first stage configured to receive the hard water and comprising a microfiltration device configured to provide filtered water, a second stage fluidically coupled to the first stage and comprising a reverse osmosis device configured to provide partially treated water, and a third stage fluidically coupled to the second stage and configured to remove a sufficient amount of remaining ionic species from the partially treated water to provide the treated water having a specific resistance greater than or equal to 1 Megohm-cm at a water recovery rate of at least 90% by volume.
